(19) United States
(12) Patent Application Publication
(10) Pub. No.: US 2004/0207496 A1
(43) Pub. Date: Oct. 21, 2004

(54) [METHOD FOR TUNING PARAMETER OF RF TRANSMISSION LINE AND STRUCTURE THEREOF]

(76) Inventors: JIH-HWA LEE, TAOYUAN (TW); CHUN-TSUN LIANG, HSINCHU (TW); CHIA-FAN YEH, TAOYUAN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,834

(22) Filed: May 12, 2003

(30) Foreign Application Priority Data
Apr. 17, 2003 (TW) 92108893

(51) Int. Cl. H01P 5/00

(52) U.S. Cl. 333/263

(57) ABSTRACT

A method for tuning parameter of RF transmission line and a structure thereof for a printed circuit board (PCB) are provided. When the PCB is being laid out, a transmission line and a plurality of copper foils are formed on the PCB in advance, and at least one tune metal, which is welded directly to the transmission line and partial or at least a copper foil, is used to replace a discrete component such as a transistor, a capacitor, or an inductor, which is working in a low frequency. Therefore, the operation of tuning parameter of the RF element on the PCB makes good use of the open stub or short stub effect occurred between the transmission line and the copper foils, so as to modify the characteristic parameter of the RF transmission line.

### BACKGROUND OF INVENTION

1. Field of Invention

The present invention relates to a method for tuning parameter of RF element and a structure thereof, and more particularly, to a method for tuning parameter of the RF transmission line on the printed circuit board by using a copper foil and a structure thereof.

2. Description of Related Art

A printed circuit board (PCB) is a circuit board formed by a plurality of patterned copper wires, and the PCB is used to assemble various electronic elements so as to configure the required electronical circuit modules. Conventionally, when assembling the discrete components on the PCB, a related discrete component, such as a resistor, a capacitor, or an inductor, is welded directly to the foil wires on the PCB by using a soldering iron. After the assembly of the discrete component is completed, a further tune is performed on the circuit, so as to comply with the required characteristic parameter, such as the input impedance, the output impedance, the filter bandwidth, and the signal gain. However, the conventional tuning method replaces the related serial connected or parallel connected discrete component with different resistor, capacitor, or inductor. Wherein, the replacement operation is performed by directly welding the discrete component, which is used to replace the original discrete component, to the original position of the copper wires on the PCB after the original discrete component is removed by using a soldering iron.

The conventional PCB are all designed for working in an operating frequency smaller than several tens of MHz or even several hundreds of KHz. Under such frequency, its corresponding wavelength (Î>>=1/f, f is frequency) is rather longer. For the elements used in the prior art, the wavelength is far longer than its element size, thus a lump concept can be applied in designing and making its equivalent circuit. Further, the discrete component frequently appears in the conventional PCB is designed and made by using such lumped elements concept, thus the element can be directly assembled on the PCB by using the soldering iron.

It is to be noted that in the wireless communication technique, the circuit of the front end RF transceiver is designed by using the concept of the microwave transmission line, and the frequency of the RF signal is about 1˜6 GHz, which is within the low frequency band of the microwave frequency. Compared with the conventional PCB, the wavelength of the RF signal is relatively shorter, and the characteristic parameter of the element it uses are approximately close to the distributed element, rather than using the lump approaching method to design the circuit like in the low frequency. Therefore, an S parameter deduced from a more precise transmission line theory is used to replace the characteristic parameter. In such case, the lump element such as the resistor, the capacitor, and the inductor, is replaced with the transmission line of the PCB, and the characteristic parameter of its circuit are also replaced with the parameters such as the return loss, the SWR, and the insertion loss.

Therefore, under the high operating frequency of the RF circuit, the circuit design using the lump element in the prior art cannot effectively calibrate the circuit characteristic. Accordingly, a simpler and faster tuning method is required to be developed.

### SUMMARY OF INVENTION

It is the first object of the present invention to provide a method for tuning parameter of the RF transmission line, wherein a metal is welded on the transmission line of the PCB so as to change the characteristic parameter of the RF transmission line.

It is the second object of the present invention to provide a RF transmission line structure, wherein a tune metal is directed welded on the transmission line of the PCB for tuning parameter.

In order to achieve the objects mentioned above, the present invention provides a method for tuning parameter of the RF transmission line for a PCB. At first, at least a transmission line and a plurality of copper foils are formed on the PCB first, and the copper foils are formed at the same time when the transmission line was patterned. Then, at least a tune metal is correspondingly disposed and connected to the transmission line and partial or at least a copper foil, and the short stub effect caused by the tune metal is used to change the characteristic parameter of the RF transmission line.

In order to achieve the objects mentioned above, the present invention provides a RF transmission line structure for a PCB. The RF transmission line structure comprises at least a transmission line, a plurality of copper foils, and a tune foil. Wherein, the copper foils are disposed on at least one side of the transmission line, and the tune metal correspondingly connects to the transmission line and partial or at least a copper foil, so as to calibrate the characteristic parameter of the RF transmission line.

In accordance with a preferred embodiment of the present invention, the tune metal mentioned above is made of a material such as copper or gold, and both sides of the tune metal are welded and fixed on the transmission line and the copper foils. Further, the copper foils are distributed in strip form or grid form on at least one side of the transmission line when they are laid out.

Since the present invention uses the tune metal, Which is directly welded to the transmission line and the copper foils, to replace the discrete component such as the resistor, the capacitor, and the inductor, which is working in a low frequency, the open stub or short stub effect occurred between the transmission line and the copper foils can be used for tuning parameter of the RF element on the PCB, so as to change the characteristic parameter of the RF transmission line.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 and FIG. 2 are the diagrams for illustrating a method for tuning parameter of the RF transmission line and a structure thereof of a preferred embodiment according to the present invention.

FIG. 3 schematically shows a diagram for illustrating the other tuning method that uses an open stub.

FIG. 4 schematically shows a diagram for illustrating a tuning method that uses a short stub.

### DETAILED DESCRIPTION

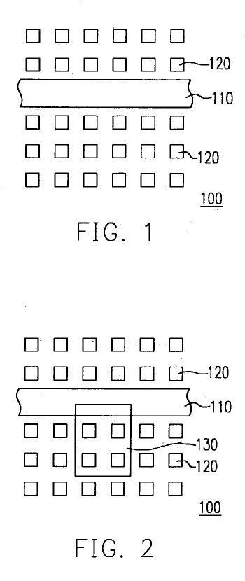

FIG. 1 and FIG. 2 are the diagrams for illustrating a method for tuning parameter of the RF transmission line and a structure thereof of a preferred embodiment according to the present invention. When the PCB 100 is being laid out, a transmission line 110 and a plurality of copper foils 120 are formed on the surface of the PCB 100, wherein the copper foils are formed on at least one side (or both sides) of the transmission line 110 at the same time when the transmission line 110 was patterned. The most common patterning process uses an etching method to remove a partial copper foil layer (not shown) on the surface of the PCB 100, and part of the copper foil layer, which has not been etched, finally forms at least one transmission line 110 and a plurality of foils 120. In the wireless communication technique, the operating frequency of the front end RF transceiver is about 1˜6 GHz, however, the conventional circuit designed by using the lump element (such as resistor, capacitor, and inductor) cannot effectively calibrate the circuit characteristic. In such case, the copper foils 120 formed on at least one side of the transmission line 110 are used for tuning parameter of the transmission line 110.

As shown in FIG. 2, a tune metal is correspondingly connected to the transmission line 110 and the partial copper foils 120 on one side of the transmission line 110, and the short stub effect generated by the tune metal 130 is used to change the characteristic parameter of the transmission line 110. Wherein, one end of the tune metal 130 is welded on the transmission line 110, and the other portion of the tune metal 130 is welded on the partial copper foils 120. Preferably, the tune metal 130 is made of a material such as a high conductive copper or gold, and the copper foils 120 are juxtaposed in one or more lines grid form on both sides of the transmission line 110. One end of the tune metal 130 is welded on an appropriate region of the transmission line 110 based on the physical tune situation, and the other portion of the tune metal 130 is welded on the appropriate region of the partial copper foils 120. Therefore, when performing the tune, the circuit characteristic parameter of the transmission line 110 is changed by the short stub effect generated by the tune metal 130, which is appropriated clipped.

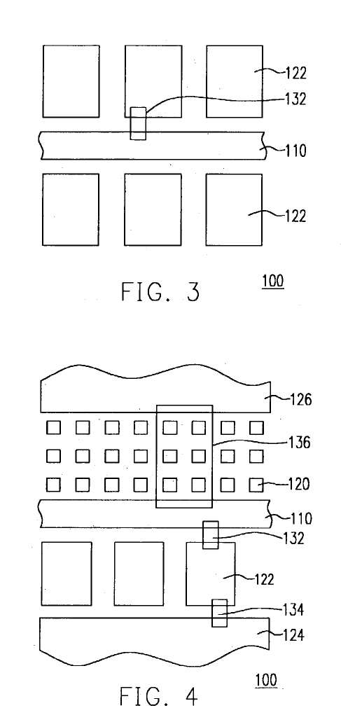

It is to be noted that by making good use of the characteristic of this short stub type of the tune metal 130, an open stub or short stub effect generated between the transmission line 110 and the copper foils 120 on the surface of the PCB 100 is used to replace the method for tuning the discrete element such as resistor, capacitor, and inductor, which is working in a low frequency in the prior art. Wherein, FIG. 2 schematically shows a diagram for illustrating a tuning method that uses an open stub, and FIG. 3 schematically shows a diagram for illustrating the other tuning method that uses an open stub. At first, a transmission line 110 and a plurality of large size copper foils 122 are formed on the surface of the PCB 100, and the copper foils are distributed in strip form on at least one side (both sides) of the transmission line 110 when they are laid out. One end of the tune metal 132 is welded on an appropriate region of the transmission line 110 based on the physical tune situation, and the other end of the tune metal 132 is welded on the appropriate region of the copper foils 122. Therefore, when performing the tune, the circuit characteristic parameter of the transmission line 110 is changed by the open stub effect generated by the welded tune metal 132.

FIG. 4 schematically shows a diagram for illustrating a tuning method that uses a short stub. At first, a transmission line 110 and a plurality of copper foils 120, 122, 124 are formed on the surface of the PCB 100, and the partial copper foils 120 are juxtaposed in grid form on one side of the transmission line 110, the partial copper foils 122 are distributed in strip form on the other side of the transmission line 110, and a plurality of large size grounding copper foils 124, 126 are further formed on its edge region (relatively away from the transmission line). Further, a plurality of tune metals 132, 134, 136 correspondingly connects to the transmission line 110 and the partial copper foils 120, 122, 124, 126, respectively. Wherein, the tune metal 132 correspondingly connects the transmission line 110 and the copper foil 122, the tune metal 134 correspondingly connects to a copper foil 122 and the grounding copper foil 124, and the tune metal 136 correspondingly connects to transmission line 110, the partial copper foil 120 and the grounding copper foil 126. Therefore, the short stub effect is generated between the transmission line 110 and the copper foils 124, 126, respectively. Therefore, when performing the tune, the circuit characteristic parameter of the transmission line 110 is changed by the short stub effect generated by the welded tune metal 132, 134, and 136.

In summary, a method for tuning parameter of RF transmission line and a structure thereof for a printed circuit board (PCB) are provided. When the PCB is being laid out, a transmission line and a plurality of copper foils are formed on the PCB in advance, and at least one tune metal, which is welded directly to the transmission line and partial or at least a copper foil, is used to replace a discrete component such as a transistor, a capacitor, or an inductor, which is working in a low frequency. Therefore, the operation of tuning parameter of the RF element on the PCB makes good use of the open stub or short stub effect occurred between the transmission line and the copper foils, so as to modify the characteristic parameter of the RF transmission line. Furthermore, the present invention is advantageous in low cost, easy tune for tuning work, and is characterized by its suitable for testing and easy for maintenance.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for tuning parameter of a RF transmission line for a PCB, comprising:
forming at least a transmission line on a surface of the PCB, and forming a plurality of copper foils on at least a side of the transmission line; and
disposing at least a tune metal to correspondingly connect the transmission line and at least one of the copper foils, and change a characteristic parameter of the transmission line by using a short stub effect generated by the tune metal.

2. The method for tuning parameter of the RF transmission line for the PCB of claim 1, wherein the transmission line and the copper foils are formed at the same time when a copper foil layer was patterned.

3. The method for tuning parameter of the RF transmission line for the PCB of claim 1, wherein the copper foils are distributed in grid form on at least a side of the transmission line.

4. The method for tuning parameter of the RF transmission line for the PCB of claim 1, wherein the copper foils juxtapose on at least a side of the transmission line.

5. The method for tuning parameter of the RF transmission line for the PCB of claim 1, wherein the tune metal is connected to the transmission line or at least a partial copper foils by using welding.

6. The method for tuning parameter of the RF transmission line for the PCB of claim 1, wherein the copper foils comprise at least a grounding copper foil, and the tune metal correspondingly connects to the grounding copper foil and the transmission line.

7. A RF transmission line structure for a PCB, comprising:
at least a transmission line, disposed on a surface of the PCB;
a plurality of copper foils, disposed on at least a side of the transmission line; and
at least a tune metal, correspondingly connecting to the transmission line and at least one of the copper foils.

8. The RF transmission line structure for the PCB of claim 7, wherein the tune metal is made of a material of either copper or gold.

9. The RF transmission line structure for the PCB of claim 7, wherein the copper foils are distributed in strip form.

10. The RF transmission line structure for the PCB of claim 7, wherein the copper foils are distributed in grid form.

11. The RF transmission line structure for the PCB of claim 7, wherein the copper foils comprise at least a grounding copper foil.
